(19) United States
(12) Patent Application Publication
(10) Pub. No.: US 2019/0373857 A1
(43) Pub. Date: Dec. 12, 2019

(54) WEARABLE APPARATUS FOR AN ANIMAL

(71) Applicant: AGERSENS PTY LTD, Camberwell (AU)

(72) Inventors: Chris LEIGH-LANCASTER, Camberwell (AU); Tanusri BHATTACHARYA, Camberwell (AU); Ian REILLY, Camberwell (AU)

(73) Assignee: AGERSENS PTY LTD, Camberwell (AU)

(21) Appl. No.: 16/550,466

(22) Filed: Aug. 26, 2019

Related U.S. Application Data
(63) Continuation of application No. PCT/AU2018/050168, filed on Feb. 27, 2018.

(30) Foreign Application Priority Data
Feb. 27, 2017 (AU) 2017900658

(51) Int. Cl. A01K 15/02; A01K 29/00; A01K 11/00

(52) U.S. Cl. CPC A01K 15/023; A01K 15/029; A01K 11/008; A01K 29/005

(57) ABSTRACT

A wearable apparatus for attaching to an animal, the apparatus comprising: a controller; and a motion sensor interfaced with the controller and configured to provide motion data to the controller, wherein the controller is arranged to implement a current behaviour modeller configured to: receive motion data from the motion sensor; and select a current behaviour from a current behaviour set comprising a plurality of predefined behaviours, such that the selected current behaviour is a prediction of an actual animal behaviour.

### CROSS REFERENCE TO RELATED APPLICATIONS

This application is a U.S. Continuation of International Application No. PCT/AU2018/050168, filed Feb. 27, 2018, and published as WO 2018/152593 A1 on Aug. 30, 2018. PCT/AU2018/050168 claims priority from Australian application number 2017900658, filed Feb. 27, 2017. The entire contents of each of these prior applications are hereby incorporated herein by reference.

### TECHNICAL FIELD

The present invention relates to a wearable apparatus for an animal, which may be used in a virtual fencing, herding, and/or shepherding system, of particular but by no means exclusive application in controlling livestock such as cattle.

### BACKGROUND

In an existing system a virtual fencing system uses battery powered collar units (in some cases supplemented by solar power) attached to the necks of cattle to provide aversive and non-aversive stimuli to the animal based on its GPS location. The stimuli prevent the individual animals moving into particular pre-defined areas of a field or pasture, thereby establishing virtual boundaries that the animals will not or are unlikely to cross.

One problem with existing virtual fencing systems (and autonomous GPS tracking systems generally) is the power drain, which either limits the period over which the collar units may be used without having to be recharged or replaced, or obliges the use of larger and heavier batteries, which the animals may find uncomfortable.

### SUMMARY OF THE INVENTION

According to an aspect of the present invention, there is provided a wearable apparatus for attaching to an animal, the apparatus comprising: a controller; and a motion sensor interfaced with the controller and configured to provide motion data to the controller, wherein the controller is arranged to a implement a current behaviour modeller configured to: receive motion data from the motion sensor; and select a current behaviour from a current behaviour set comprising a plurality of predefined behaviours, such that the selected current behaviour is a prediction of an actual animal behaviour.

Optionally, the apparatus further comprises a location sensor interfaced with the controller and configured to provide location data to the controller, wherein the current behaviour modeller is configured to receive location data from the location sensor and wherein generation of the prediction of a current behaviour of the animal is at least based on the location data.

The motion sensor may comprise an inertial motion unit. The apparatus may further comprise a GPS receiver, and the inertial motion unit may be configured to provide the controller with location data and the output of the inertial motion unit may be fixed by an output of the GPS receiver.

The apparatus optionally further comprises: at least one stimulus output for providing a stimulus to the animal; a power supply including at least a battery, the power supply arranged to power the controller, the at least one sensor, and the, or each, stimulus output. The apparatus may include at least one stimulus electrode. The apparatus may include an audio output.

Optionally, the wearable apparatus is provided with virtual fence location information, and the controller is configured to operate the at least one stimulus output at least in dependence on current location data and the virtual fence location information.

Optionally, the wearable apparatus is provided with virtual fence location information, and the controller is configured to operate the at least one stimulus output at least in dependence on current motion data and the virtual fence location information.

Optionally, the wearable apparatus is provided with virtual fence location information, and wherein the controller is configured to operate the at least one stimulus output at least in dependence on a predicted current behaviour of the animal and the virtual fence location information.

Optionally, the controller is arranged to implement a power manager configured to control the operation of at least one electrically powered component of the wearable apparatus. The power manager may be configured to control at least one sensor. The power manager may be configured to control the operation of the GPS receiver. The power manager may be configured to determine a sleep period and to place the controller into a sleep mode for the determined sleep period. The power manager may be configured to control the operation of at least one electrically powered component of the wearable apparatus at least in accordance with a predicted current behaviour. The power manager may be configured to control the operation of at least one electrically powered component of the wearable apparatus at least in accordance with current location data and/or motion data.

Optionally, the controller is arranged to implement a predictive behaviour modeller configured to determine a probability of a future behaviour based on at least the predicted current behaviour. The power manager may be configured to control the operation of at least one electrically powered component of the wearable apparatus at least in accordance with the predicated future behaviour.

Optionally, the controller is configured to receive data from at least two different sensors, and the current behaviour modeller is configured to distinguish between two predefined behaviours which are associated with similar outputs of one of the sensors.

According to another embodiment of the present invention, there is provided a virtual fencing or herding system, comprising one or more wearable apparatuses according to the previous aspect, and a base station in data communication with the one or more wearable apparatuses. The, or each, wearable apparatus may be provided with virtual fence location information via data communication with the base station.

According to another aspect of the present invention, there is a method for operating a controller implemented within a wearable apparatus for attaching to an animal, the method comprising: receiving motion data from a motion sensor interfaced with the controller, selecting a current behaviour from a current behaviour set comprising a plurality of predefined behaviours, such that the selected current behaviour is a prediction of an actual animal behaviour.

Typically, the controller is a controller of a wearable apparatus of the first aspect.

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention can be more clearly ascertained, embodiments will now be described, by way of example, with reference to the accompanying drawings, in which:

FIG. 1 is a schematic diagram of a virtual fencing system according to an embodiment of the present invention;

FIG. 2 is a schematic diagram of certain principal operational components of each collar of the virtual fencing system of FIG. 1;

FIG. 3 is a schematic diagram of an exemplary behavioural model as used in the collars of the virtual fencing system of FIG. 1;

FIG. 4 is a schematic diagram of a Markov Chain for a behavioural model implemented by the Predictive Behaviour Modellers of the collars of the virtual fencing system of FIG. 1; and

FIG. 5 shows an example of decision making by the Current Behaviour Modeller.

### DETAILED DESCRIPTION

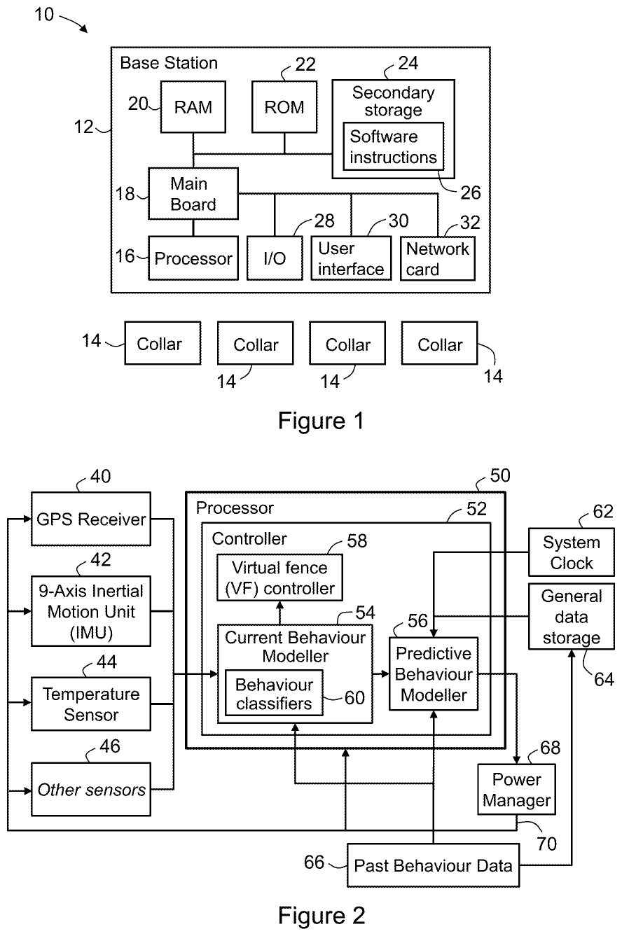

According to an embodiment, there is provided a virtual fencing system 10, as shown schematically at 10 in FIG. 1. The term “virtual fencing” may be, for the purposes of the present disclosure, equivalent to “virtual herding” or “virtual shepherding”.

System 10 includes a base station 12 and one or more wearable apparatus (in the embodiments described herein, the wearable apparatuses are collars 14). The collars 14 are generally designed to be wearable by an animal. For example, for the embodiments herein described, the collars 14 are configured to be worn by a specific domesticated animal, in this example cattle, that are to be virtually fenced. It will be noted that FIG. 1 depicts four such collars 14, but it will be appreciated that the actual number of collars either provided or deployed with system 10 can be varied as desired. Generally, the wearable apparatuses may be of any suitable type—for example, this may depend at least in part on the type of animal.

Base station 12 includes a processor 16 mounted on a circuit board 18. Base station 12 includes memory in the form of volatile and non-volatile memory, including RAM 20, ROM 22 and secondary or mass storage 24; the memory is in data communication with processor 16. Instructions and data to control operation of processor 16 are stored in the memory; these include software instructions 26 stored in secondary storage 24 which, when executed by processor 16, implement each of the processes carried out by base station 12, and which are copied by base station 12 to RAM 20 for execution, when required.

Base station 12 also includes an input/output (I/O) interface 28 for communicating with peripheral devices of system 10. These peripheral devices include a user interface 30 of base station 12. User interface 30 is shown for convenience in FIG. 1 as a part of base station 12, but in practice user interface 30—which commonly comprises a keyboard, one or more displays (which may be touch screen displays) and/or a mouse—may be integral with base station 12, such as if base station 12 is provided as a portable computing device, or provided as a separate component or components, such as if base station 12 is provided as a computer, such as a personal computer or other desktop computing device. In this case, the peripheral devices (e.g. user interface 30) may be remotely located with respect to the base station 12—for example, a computer is provided in network communication with the base station 12.

System 10 also includes a wireless telecommunications network (not shown) to facilitate communication between base station 12 and collars 14. In this embodiment, the wireless telecommunications network is in the form of a LoRa (trade mark) LPWAN (Low Power Wide Area Network), or an alternative LPWAN such as a SIGFOX (trade mark) LPWAN or an Ingenu (trade mark) RPMA (Random Phase Multiple Access) LPWAN. In addition, base station 12 includes a communications interface, for example a network card 32. Network card 32, for example, sends data to and receives data from collars 14 via the aforementioned wireless telecommunications network (whether an existing network or one tailored to the requirements of system 10).

In this embodiment, the LoRa LPWAN (as would be the case with other LPWANs) employs a transmitter (not shown) in each of collars 14 and a gateway (not shown) provided with a multi-channel receiver or receivers for facilitating communication with the transmitters. These elements may be regarded as a part of system 10, or as external to but cooperating with system 10. The LoRa LPWAN also employs a telecommunications connection between the gateway and base station 12; this telecommunications connection is in the form, in this embodiment, of a cellular connection to a mobile telephony network or an Ethernet connection, back to a router (not shown) of base station 12.

In some applications, the farm or other property may be too large for convenient use of this arrangement. This may be so with larger properties of, for example, greater than for 6,000 Ha. In such cases, one or more additional gateways may be required and sufficient (if, for example, there is good cellular coverage on the property) or repeaters where an internet connection is limited.

Base station 12 is operable to send command signals to each of collars 14 (using the LoRa LPWAN discussed above) and to receive data from collars 14 on the status, behaviour, etc., of the animals and the operation of collars 14. Base station 12 can also be operated to create and control the virtual fence, including the specification of the location of each section of the virtual fence and of the stimuli to be applied to the animals. The virtual fence and stimuli specifications are transmitted by base station 12 to the collars 14 whenever established or modified, for use by the respective collar's virtual fence controller (described below).

Certain principal operational components of each collar 14 are shown schematically in more detail in FIG. 2. It should be appreciated that certain of the illustrated components may be provided—as convenient or when found to be technically preferable—in either collars 14 or base station 12.

Referring to FIG. 2, collars 14 include a controller 52 interfaced with a location sensor and a motion sensor, which typically comprises a velocity sensor and/or an acceleration sensor. In an embodiment, these sensors are in the form of an inertial motion unit (IMU) 42 (in this example a 9-axis inertial motion unit, which also includes a magnetic compass). In this embodiment, IMU 42 comprises a 9DOF IMU, which typically comprises a 3-axis accelerometer, a magnetometer and a gyroscope. It does not include a velocity sensor as such, but velocity can be calculated from acceleration.

Each collar 14 also includes a power supply (in the present example, comprising a battery pack (not shown) and a solar panel (not shown)), and at least one stimulus output for providing a stimulus to the animal selected from: an audio output (not shown) for emitting an audio stimulus; and one or more stimulus electrode(s) (not shown) for applying selected stimuli to the animal. The battery pack and solar panel provide electrical power for powering the respective collar 14 and its electrodes. The solar panels also charge the battery pack, but directly power the respective collar 14 and its electrodes whenever there is sufficient insolation; this is managed by a power manager (described below). Collars 14 may optionally include other sensors 46 as desired. For example, in an embodiment, the collar 14 further comprises a temperature sensor 44. In another example, an embodiment of the collar 14 further comprises an ambient light sensor (not shown).

In an embodiment, the IMU 42 is configured to provide location data and motion data (e.g. typically speed and heading) to the controller 52. In this embodiment, a GPS receiver 40 of the collar 14 is configured to periodically calibrate (i.e. fix) the location of the IMU 42, and therefore its associated collar 14. Thus, the GPS receiver 40 does not directly provide location data to the collar 14. Advantageously, the IMU 42 can provide location and motion data with a lower lag when compared to the GPS receiver 40 and with less power usage. The period between fixing the IMU 42 location can be preconfigured and constant or dynamically calculated. Typically, the period is sufficiently short such that predicted maximum drift error does not exceed a predetermined value. Such an embodiment may be considered to employ “dead reckoning” or “inertial navigation”. In an implementation, the IMU 42 provides only motion data (typically acceleration data) and the controller 52 calculates the location data based on the IMU 42 output and the GPS based fixing.

In another embodiment, the GPS receiver 40 is configured to determine the location of the respective animal and to provide this location data to the collar 14.

Thus, the motion sensors may be used to determine the location of the respective animal (from GPS receiver 40 and/or IMU 42), the motion status of the animal (from GPS receiver 40 and/or IMU 42) and the trajectory of the animal when moving (from the magnetic compass in IMU 42 and/or GPS receiver 40).

Collars 14 also include a processor (CPU) 50, which implements the controller 52.

In an embodiment, the controller 52 is arranged to implement a virtual fence controller 58 which is configured to utilise current location data and optionally motion data in order to determine whether the stimulus electrodes should be activated to apply stimulus to the animal and—if so—the type of stimulus. The determination is made in accordance with the virtual fence and stimuli specifications (received from base station 12). This determination may be performed according to any suitable (typically pre-defined) stimulus algorithm that determines what stimulus is applied and when, and is processed in real-time in collar 14 by virtual fence controller 58. Virtual fence controller 58 then controls the audio output and the stimulus electrodes to output the determined audio and electrical stimulus.

### Current Behaviour Modeller

According to an embodiment, the controller 52 is arranged to implement a Current Behaviour Modeller 54, which is configured to make a prediction of a current behaviour of the animal to which the collar 14 is attached. Current Behaviour Modeller 54 utilises one or more predefined behaviour classifiers 60. Current behaviour is predicted by the Current Behaviour Modeller 54 at least based on an output of the motion sensor. Typically, the Current Behaviour Modeller 54 uses a combination of sensor output from one or more sensors 40 to 46.

The predicted current behaviour is selected from a set of predefined behaviours. In an embodiment, there are two predefined behaviours, namely moving and stationary. However, it may be preferred that the predefined behaviours allow for a more detailed prediction of the current status of the animal. For example, an embodiment may include the following predefined behaviours: walking; grazing; resting; standing; ruminating; and grooming. Generally, the desired predefined behaviours can be selected based on the intended use of the collar 14 (e.g. in dependence on the animal type and/or breed). In an implementation, the set of predefined behaviours can be modified via communication received by the collar 14 from the base station 12 (e.g. predefined behaviours can be added or removed).

The Current Behaviour Modeller 54 receives location data and motion data obtained by the GPS receiver 40 and/or IMU 42 (depending on the embodiment). Either or both of the location data and motion data may be in a raw format, in which case, the Current Behaviour Modeller 43 is configured to process the location and motion data into a useable format. Alternatively, at least one of the location data and motion data is provided in a useable format from the relevant sensor.

Generally, the one or more behaviour classifiers 60 are selected such as to enable an accurate prediction of the animal's current behaviour based on the current sensor output. Research in this art has demonstrated that classifiers like State Vector Machines (SVMs), Decision Trees (DTs) and Linear Discriminants (LAs) may reliably identify cattle behaviour (Smith, et al., 2015) and therefore be useful as behaviour classifiers 60. Stepwise regression models and Hidden Markov Models (HMMs) have also been used with some success (Ying, Corke, Bishop-Hurley, & Swain, 2009).

In an embodiment, one or more of these classifiers are utilised as the one or more predetermined predefined behaviour classifiers 60. For ease of description, reference is made below to a single behaviour classifier 60 although it is understood this may be extended to several behaviour classifiers 60.

The behaviour classifier 60 utilises one or more parameters (herein, reference is made to several parameters) which act, effectively, to “train” the behaviour classifier 60 as to the relationship between the output of one or more of the sensors 40 to 46 (typically including at least one of the location sensor and motion sensor) and the current animal behaviour. In an embodiment, the parameters are determined in accordance with previously obtained motion data from actual animals (which may be the same animals as those with collars 14 presently attached, or may be similar animals such as those of a same breed). The actual animals may also be observed such that at different times the behaviours of the animals can be determined by an observer (e.g. a user). The observer then labels the animal behaviour such that each instance of motion data is associated with a labelled animal behaviour. The behaviour classifier 60 is then utilised to determine a set of parameters which can be later used to determine a current behaviour of an animal. In an embodiment, machine learning techniques are utilised when determining the one or more parameters.

Thus, the behaviour classifier 60 is employed by Current Behaviour Modeller 54 utilising the parameters in order to identify particular behaviours when presented with new motion data. The result is that the Current Behaviour Modeller 54 determines a prediction of the current behaviour of the animal, based on the behaviour classifier 60 and current sensor output.

According to the described embodiment, collars 14 also include a system clock 62, general data storage 64 (which may include diurnal and seasonal cycle behavioural patterns for the animal as well as breed-specific behavioural modifiers), past behaviour patterns 66 and a power manager 68. Past behaviour patterns 66 may be specific to an actual animal with which a particular collar 14 is to be used, but for expediency they may relate to the breed or herd in general. This is expected generally to be satisfactory, as the behaviour of a group of domestic animals will usually exhibit some common patterns. Nonetheless, in one embodiment past behaviour patterns 66 are updated dynamically—for each animal individually—as system 10 learns from Current Behaviour Modeller 54 about each animal's individual patterns of behaviour.

Past behavioural patterns 66 may be used internally within the collar processes to optimize the results of Current Behaviour Modeller 54 for each animal via a machine learning algorithm to provide more accurate behaviour interpretation. The actual detected behaviour of the animal is used to update the default probabilities for a Markov chain (discussed below), such that closed loop control/optimization of Markov chain probabilities is effected. This optimization would be specific to the individual animal wearing the collar 14. The analytics for optimizing Current Behaviour Modeller 54 may run in collar 14 itself (the node) or within base station 12 (gateway).

In an embodiment, the virtual fence controller 58 is configured to utilise an output of the Current Behaviour Modeller 54 when determining whether the stimulus electrodes should be activated. For example, although the location data and motion data of the animal may indicate a certain action should be taken, this may be modified or in fact reversed due to the determined behaviour of the animal.

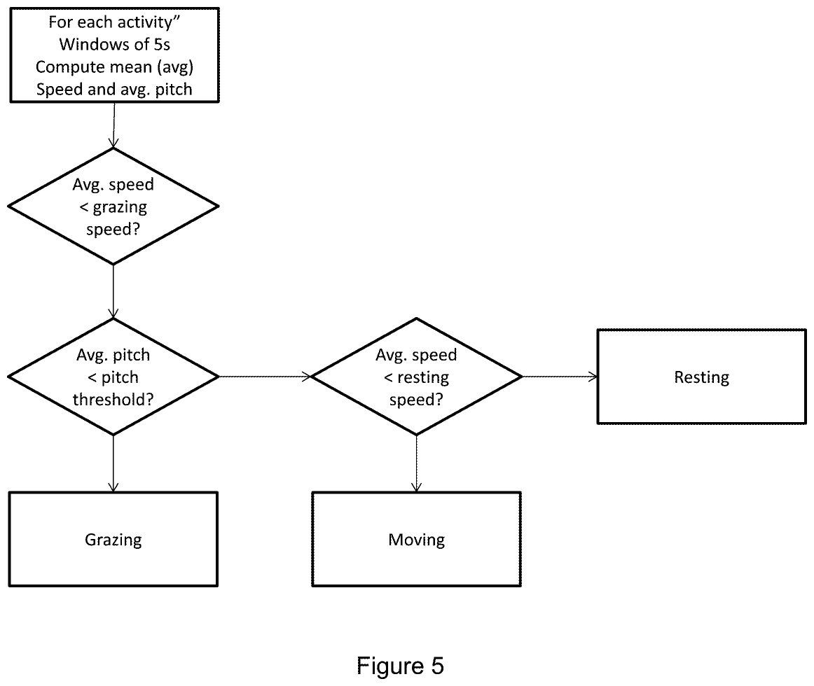

In an embodiment, with reference to FIG. 5, the Current Behaviour Modeller 54 is configured to utilise a decision tree model. A first test is made, whereby one or more sensor outputs are checked. As a result of the check, the decision tree moves along one of a plurality of branches. This process is repeated until a current behaviour is determined.

In the example shown, where the behaviours of “moving”, “grazing”, and resting” form the set of predefined behaviours. A first check is whether the measured speed of the collar 14 (and thus, animal) is less than a predefined grazing speed (i.e. a maximum speed associated with the behaviour of grazing). In the event that the speed is not less than the predefined grazing speed, then the decision tree indicates that the current behaviour is “moving”. However, if the speed is less than the predefined grazing speed, then the decision tree moves to a step of checking the pitch. At this step, a check is made as to whether the pitch angle of the collar 14 (roughly corresponding to the angle of the neck of the animal) is below a predefined angle. In the event that the angle is lower, the decision tree determines that the current behaviour is “grazing”. However, if the pitch is greater than the predefined angle, then the decision tree moves to a step of checking the speed once again. However, in this case, it has already been determined that the animal is not grazing. Therefore, the decision tree makes a check (based on the speed) as to whether the animal is “resting” or “moving”.

Overall, implementing a decision tree (or other suitable decision making algorithm) may advantageously allow the Current Behaviour Modeller 54 to distinguish between behaviours that share some similar sensor output values.

### Predictive Behaviour Modeller

According to an embodiment, the controller 52 is arranged to implement a Predictive Behaviour Modeller 56, which is configured to make a prediction of a future behaviour of the animal to which the collar 14 is attached.

Predictive Behaviour Modeller 56 typically receives current behaviour data from the Current Behaviour Modeller 54. Generally, the Predictive Behaviour Modeller 56 applies a pre-established (though optionally dynamically updatable) behaviour model to that data to predict the near-term future behaviour of the animal. In an embodiment, this prediction may be used by power manager 68 to determine whether to adjust power consumption of components of the respective collar 14 (in this embodiment, optionally one or more of the sensors 40 to 46 and optionally processor 50)—including whether to put one or more of those components to sleep for a pre-determined period in order to preserve battery charge. Power manager 68 implements these determinations by adjusting the power consumption settings of the respective components.

The future behaviour model implemented by Predictive Behaviour Modeller 56 may be of any acceptably reliable form. Whether a particular model is acceptably reliable can be readily determined through experimental trials to monitor the efficacy of enforcement by system 10 of the virtual fence and the extension of battery life due to the operation of power manager 68.

In an embodiment, the Predictive Behaviour Modeller 56 implements a behavioural model that incorporates a set of Markov Chains that uses the determined current behaviour and optionally previously determined behaviour of the animal to predict a future behaviour of the animal (“future behaviour”). Generally, the future behaviour may be a future behaviour within a predetermined timeframe. A future behaviour is selected from a set of predefined future behaviours. The future behaviours may be the same as the predefined behaviours utilised by the Current Behaviour Modeller 54, or may vary.

Markov Chains are a probabilistic process that relies on a future state being dependent on a current state in some way. In the present application, it is expected that that a future behaviour can be dependent, at least to an estimated probability, on the determined current behaviour of the animal. For instance, if a cow is determined to be currently resting then there is a certain probability (based on the factors upon which the behavioural model has been developed) that it will start walking—and hence its future behaviour state (as a basic Markov Chain model predicts only the next future state based on the current state). Generally, the possible future behaviours include a behaviour corresponding to the determined current behaviour (e.g. a cow may continue to be resting or may continue grazing).

Various behavioural models that incorporate Markov Chains have been proposed for prediction of animal behaviour. These include basic Hidden Markov Models, continuous-time Markov chains (Metz, Dienske, De Jonge, & Putters, 1983), and multi-stream cyclic Hidden Markov Models (Magee & Boyle, 2000). Predictive Behaviour Modeller 56 may be configured to employ any of these, according to alternative embodiments of system 10.

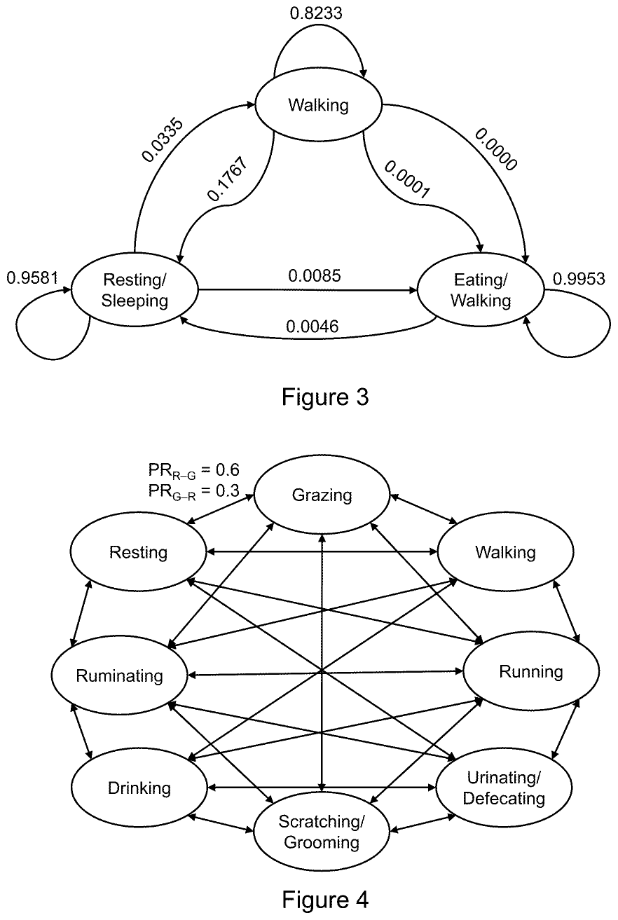

An example of a suitable behavioural model is shown schematically in FIG. 3. The model comprises a Hidden Markov Model (Ying, Corke, Bishop-Hurley, & Swain, 2009), which is based on a study of six cattle. In FIG. 3, the probabilities of transitioning from one behaviour (or “state”) to another are shown on the connecting branches of the model. As may be seen from the figure, for example, the probability of transitioning from “resting/sleeping” (determined current behaviour) to “walking” (possible future behaviour) is—in this model—0.0335, while the probability of transitioning from “walking” to “eating/walking” is essentially zero.

Based on the current behaviours and future behaviours utilised by the Current Behaviour Modeller 54 and Predictive Behaviour Modeller 56, a Markov Chain for the cattle behavioural model implemented by Predictive Behaviour Modeller 56 may look generally as shown in FIG. 4 (Bishop-Hurley, 2015). The probabilities of transitioning from one state to another (e.g. PR_{R-G} in FIG. 4) is determined experimentally from field trials but may be changed dynamically based on a number of factors, such as:
The specific breed of the animal—genetic signature
The diurnal and/or seasonal cycle,
The animal's location in the field or paddock (e.g. near water or shade),
The geographic location of the field or farm,
The direction of movement of the animal (e.g. away from the virtual fence or towards the virtual fence),
The time of day,
The age of the animal,
The oestrus status of the animal,
The health status of the animal,
The pregnancy status of the animal,
The sex status of the animal—e.g. heifer, steer, cow.

Additional information of this kind may be stored for a specific animal in general data storage 64, updated as it changes (e.g. from “not pregnant” to “pregnant”) from base station 12, or determined from sensor data (e.g. animal temperature and behaviour can be used to predict oestrus status).

### Power Management

According to an embodiment, there is provided a power manager 68 configured to control the operation of at least one electrically powered component of the collar 14. Generally, the power manager 68 is configured to control operation of one or more of the sensors 40 to 46, the controller 52, or any other controllable electrical component.

According to an implementation, the power manager 68 is configured to control operation of the at least one electrically powered component in accordance with a predicted current behaviour. For example, sensors 40 to 46 may be put into a sleep mode for a determined period of time if a current behaviour indicates that the animal is asleep. Alternatively, sensors 40 to 46 may be activated if it is determined that the current behaviour indicates that the animal is moving.

According to another implementation, the power manager 68 is configured to control operation of the at least one electrically powered component in accordance with a predicted current behaviour and the relative distance between the collar 14 and a virtual fence.

For example, power management decisions made and implemented by power manager 68 are shown in Table 1 (VF corresponds to a virtual fence).

TABLE 1
Exemplary Power Management Decisions

| Animal | Animal | Animal Motion | Power Management |
|---|---|---|---|
| Behaviour | Location | Direction | Decision |
| Walking | At VF | Towards VF | GPS and IMU active |
| Grazing | Near VF | Away from VF | Sleep GPS for 30 s then, upon |
| | | | awakening, recheck state and |
| | | | VF parameters (location, |
| | | | heading, velocity) |
| Grazing | Far from | N/A | Sleep GPS and CPU for 5 min |
| far from | VF | | then recheck state and VF |
| VF | | | parameters on wake (location, |
| | | | heading, velocity) |
| Resting | Near VF | None - | Sleep all devices for 1 h and |
| | | stationary | recheck state on wake |
| Sleeping | Far from | N/A | Sleep all devices for 2 h and |
| | VF | | recheck state on wake |

According to another implementation, the predicted future behaviour of the animal for the next period—i.e. the predetermined timeframe—(typically from half a minute to an hour or two) then enables informed decisions to be made by power manager 68 about the optimal powered state of various devices in the collar, from the perspective of minimizing power usage. The current location and optionally motion of the animal is also considered in combination with the predicted future behaviour of the animal.

The power management decisions of power manager 68 are made based on a combination of the animal's location relative to the VF (virtual fence), instantaneous motion status from the IMU 42, the current behavioural state of the animal and the predicted future behavioural state of the animal. The definitions of “at”, “near” or “far from” the VF are dependent on the number and geometry of active virtual fence boundaries around the animal, and the proximity of each respective animal to a boundary. For a linear VF, the perpendicular distance of the animal from the fence is employed in such decisions; for a non-linear VF, multiple fences or a closed boundary, a more complicated calculation based on shortest distance from the animal to an adjacent VF boundary is employed.

Once power manager 68 has made a decision, a control signal 70 suitable for adjusting the respective power consumption settings is transmitted to the relevant sensor or sensors 40 to 46 and/or to processor 50, thereby implementing the decision.

In an embodiment, the collar 14 is enabled to detect, when in a sleep mode, a change in animal behaviour. The detection is made in a low power mode. In an example, the controller 52 has determined that a current behaviour is non-moving (e.g. asleep). The IMU 42 is configured to make occasional measurements in order to determine if the collar 14 is in motion. If the IMU 42 detects, in a sequence of measurements, that the collar 14 is in motion, the controller 52 enters an intermediary stage where further samples are made of the IMU 42 in order to detect whether the collar 14 is actually in motion, using the predefined behaviour classifiers 60 of the Current Behaviour Modeller 54. If it is determined that the collar 14 is in motion, then the controller 52 enters a normal powered mode. If it is determined that the collar 14 is not in motion, a power saving decision will be made (eg. the collar 14 or some components of the collar 14, may continue to operate in a sleep mode).

It will be understood to those persons skilled in the art of the invention that many modifications may be made without departing from the scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will also be understood that the reference to any prior art in this specification is not, and should not be taken as, an acknowledgement or any form of suggestion that, the prior art forms part of the common general knowledge in any country.

### REFERENCES

Bishop-Hurley, G. (2015). QAAFI Science Seminar—Precision Livestock Management. Brisbane St Lucia: The University of Queensland.
Magee, D. R., & Boyle, R. D. (2000). Detecting Lameness in Livestock Using ‘Re-sampling Condensation’ and ‘Multi-stream Cyclic Hidden Markov Models’. Proceedings of the British Machine Vision Conference.
Metz, H. A., Dienske, H., De Jonge, G., & Putters, F. A. (1983). Continuous-Time Markov Chains as Models for Animal Behaviour. Bulletin of Mathematical Biology, 643-658.
Smith, Little, Greenwood, Valencia, Rahman, Ingham, Bishop-Hurley, Shahriar & Hellicar. (2015). A Study of Sensor Derived Features in Cattle Behaviour Classification Models. 2015 IEEE Sensors.
Ying, Corke, Bishop-Hurley, & Swain. (2009). Using accelerometer, high sample rate GPS and magnetometer data to develop a cattle movement and behaviour model. Ecological Modelling.

1. A wearable apparatus for attaching to an animal, the apparatus comprising:
a controller; and
a motion sensor interfaced with the controller and configured to provide motion data to the controller,
wherein the controller is arranged to implement a current behaviour modeller configured to:
receive motion data from the motion sensor; and
select a current behaviour from a current behaviour set comprising a plurality of predefined behaviours,
such that the selected current behaviour is a prediction of an actual animal behaviour.

2. A wearable apparatus as claimed in claim 1, further comprising a location sensor interfaced with the controller and configured to provide location data to the controller,
wherein the current behaviour modeller is configured to receive location data from the location sensor and wherein generation of the prediction of a current behaviour of the animal is at least based on the location data.

3. A wearable apparatus as claimed in claim 1, wherein the motion sensor comprises an inertial motion unit.

4. A wearable apparatus as claimed in claim 3, further comprising a GPS receiver, and wherein the inertial motion unit is configured to provide the controller with location data and wherein the output of the inertial motion unit is fixed by an output of the GPS receiver.

5. A wearable apparatus as claimed in claim 1, further comprising:
at least one stimulus output for providing a stimulus to the animal;
a power supply including at least a battery, the power supply arranged to power the controller, the at least one sensor, and the, or each, stimulus output.

6. A wearable apparatus as claimed in claim 5, including at least one stimulus electrode.

7. A wearable apparatus as claimed in claim 5, wherein the wearable apparatus is provided with virtual fence location information, and wherein the controller is configured to operate the at least one stimulus output at least in dependence on current location data and/or current motion data and the virtual fence location information.

8. A wearable apparatus as claimed in claim 5, wherein the wearable apparatus is provided with virtual fence location information, and wherein the controller is configured to operate the at least one stimulus output at least in dependence on a predicted current behaviour of the animal and the virtual fence location information.

9. A wearable apparatus as claimed in claim 5, further comprising a power manager configured to control the operation of at least one electrically powered component of the wearable apparatus.

10. A wearable apparatus as claimed in claim 9, wherein the power manager is configured to control at least one sensor.

11. A wearable apparatus as claimed in claim 10, further comprising a GPS receiver, and wherein the inertial motion unit is configured to provide the controller with location data and wherein the output of the inertial motion unit is fixed by an output of the GPS receiver, and wherein the power manager is configured to control the operation of the GPS receiver.

12. A wearable apparatus as claimed in claim 9, wherein the power manager is configured to control the operation of at least one electrically powered component of the wearable apparatus at least in accordance with a predicted current behaviour and/or current location data and/or motion data.

13. A wearable apparatus as claimed in claim 9,
wherein the controller is arranged to implement a predictive behaviour modeller configured to determine a probability of a future behaviour based on at least the predicted current behaviour.

14. A wearable apparatus as claimed in claim 13, wherein the power manager is configured to control the operation of at least one electrically powered component of the wearable apparatus at least in accordance with the predicated future behaviour.

15. A wearable apparatus as claimed in claim 1, wherein the controller receives data from at least two different sensors, and wherein the current behaviour modeller is configured to distinguish between two predefined behaviours which are associated with similar outputs of one of the sensors.

16. A virtual fencing or herding system, comprising one or more wearable apparatuses as defined in claim 1, and a base station in data communication with the one or more wearable apparatuses.

17. A virtual fencing or herding system as claimed in claim 16, wherein the, or each, wearable apparatus is provided with virtual fence location information via data communication with the base station.

18. A method for operating a controller implemented within a wearable apparatus for attaching to an animal, the method comprising:
receiving motion data from a motion sensor interfaced with the controller,
selecting a current behaviour from a current behaviour set comprising a plurality of predefined behaviours, such that the selected current behaviour is a prediction of an actual animal behaviour.

19. A wearable apparatus as claimed in claim 1, wherein the current behaviour set comprises at least two predefined behaviours associated with motion data indicating a stationary animal and/or at least two predefined behaviours associated with motion data indicating a moving animal.

20. A method as claimed in claim 18, wherein the current behaviour set comprises at least two predefined behaviours associated with motion data indicating a stationary animal and/or at least two predefined behaviours associated with motion data indicating a moving animal.
